(19) United States
(12) Patent Application Publication
(10) Pub. No.: US 2006/0023172 A1
(43) Pub. Date: Feb. 2, 2006

(54) Illuminating device and projection type video display

(75) Inventors: Takashi Ikeda, Osaka (JP); Shouichi Yoshii, Osaka (JP); Yoshihiro Yokote, Osaka (JP); Makoto Maeda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., Moriguchi-City (JP)

(21) Appl. No.: 11/191,277

(22) Filed: Jul. 28, 2005

(30) Foreign Application Priority Data
Jul. 28, 2004 (JP) 2004-220077
Jun. 24, 2005 (JP) 2005-184237

(51) Int. Cl. G03B 21/26

(52) U.S. Cl. 353/94

(57) ABSTRACT

An illuminating device comprises a first light source in which LED chips are arranged in an array shape and a second light source in which LED chips are arranged in an array shape. The two light sources of each illuminating device are arranged such that the main light-emission optical axes of the light sources are perpendicular to each other. Moreover, a time-division switching mirror is provided at a crossing position between the main light-emission optical axes. The first light source and the second light source alternately emit pulses of light. The pulsed emission is a method of supplying a large amount of electric currents to the LED chips in a short time period, and a light-emitting amount increases compared to a steady-state emission of the LED chips. The time-division switching mirror becomes a transmitting state when the first light source is lighted, and becomes a reflecting state when the second light source is lighted.

### BACKGROUND OF THE INVENTION

Field of the Invention

The present invention relates to an illuminating device and a projection type video display.

Generally, an illuminating device used for a liquid crystal projector is formed of a lamp such as an ultra-high pressure mercury lamp, a metal halide lamp, a xenon lamp, and etc., and a parabolic reflector for collimating its irradiating light. In addition, in such the illuminating device, in order to reduce a non-uniformity of a light amount on an irradiating surface, there is sometimes provided an integrating function by a pair of fly's eye lenses (referred to as a function for superimposing and converging plural illuminating areas of predetermined shape formed by sampling within a plane surface by an optical device on an object to be illuminated). Furthermore, in recent years, from the viewpoint of power saving, or others, it is attempted to use a light-emitting diode (LED) as the light source (see Japanese Patent Application Laying-open No. 10-186507).

### SUMMARY OF THE INVENTION

However, it appears to be a reality that a practical illuminating device using the light-emitting diode has not been realized.

In view of the above circumstances, it is an object of the present invention to provide a practical illuminating device using a solid light element such as a light-emitting diode and others, and a projection type video display using the illuminating device.

In order to solve the above-described problems, an illuminating device according to the present invention comprises a plurality of light sources formed of one or a plurality of solid light-emitting elements and arranged so as to face different directions one another, a lighting control means for allowing the solid light-emitting element to emit pulses of light, and an optical path changing means for generating a state where light emitted by a pulsed emission in one light source is guided to a specific optical path and a state where light emitted by a pulsed emission in another light source is guided to the specific optical path (hereinafter, referred to as a first configuration in this section).

A peak light amount is further increased in a case where the solid light-emitting elements are allowed to emit pulses of light by passing a large amount of electric currents instantaneously than in a case where the solid light-emitting elements are allowed to emit light in a steady-state manner by passing a steady-state current, so that an amount of emitted light in the illuminating device is increased. In addition, between a pulsed emission of a certain solid light-emitting element and a next pulsed emission of the same solid light-emitting element, it is possible to allow another solid light-emitting element to emit pulses of light. As a result, it is possible to further increase the total light amount in this case than in a case where solid light-emitting element is allowed to emit light in a steady-state manner. Herein, in a case where a plurality of light sources face the same direction (optical axes of the respective light sources are in parallel with one another), the substantial light-emitting area becomes larger than an object to be illuminated, so that a parallelism of light fluxes guided to the object to be illuminated is likely to be reduced. On the contrary, with such the invention, a plurality of light sources are faced in different directions and the optical path changing means is provided. As a result, a substantial light-emitting area becomes smaller than the object to be illuminated, so that the parallelism of light fluxes guided to the object to be illuminated can be improved. In other words, it is possible shorten a distance from the illuminating device to the object to be illuminated.

In the above-described first configuration, the optical path changing means may be formed of a transmission and reflection switching means for switching between the transmission and the reflection. The transmission and reflection switching means may be formed of a switching diffraction element for switching between the transmission and the reflection by an energization control synchronous with the pulsed emission. In addition, in the illuminating device according to such the configuration, three light sources are provided, and the switching diffraction elements may be arranged crosswise on a crossing position of the light emitted from the three light sources.

Furthermore, in an illuminating device provided with the transmission and reflection switching means, the transmission and reflection switching means may have transmitting regions and reflecting regions alternately in a plane surface and may switch positions of the transmitting regions and the reflecting regions by a reciprocating movement synchronous with the pulsed emission.

Or, in an illuminating device provided with the transmission and reflection switching means, the transmission and reflection switching means may have the transmitting regions and the reflecting regions alternately in a circular disk, and may switch positions of the transmitting regions and the reflecting regions by a rotation synchronous with the pulsed emission.

In the first configuration, the optical path changing means may be formed of a transmission optical path changing means for changing an optical path direction when light is transmitted. In an illuminating device of such the configuration, the transmission optical path changing means may be formed of a switching diffraction element for changing an advancing direction of light by diffraction according to an energization control synchronous with the pulsed emission. Furthermore, in an illuminating device according to such the configuration, three light sources are provided, and the switching diffraction elements may be arranged crosswise on a crossing position of light emitted from the three light sources.

In the first configuration, the optical path changing means may be formed of a reflection optical path changing means for changing an advancing direction of light by reflection. In an illuminating device of such the configuration, the reflection optical path changing means may be formed of a mirror device for changing a direction of a mirror by an energization control synchronous with the pulsed emission.

The illuminating devices of such the configurations may comprise a first fly's eye lens provided on a light-emission side of each light source, and a second fly's eye lens provided on the specific optical path, paired with the first fly's eye lens, and integrating and guiding light to an object to be illuminated. In addition, in this configuration, the illuminating device may comprise a polarization conversion system on a light-exit side of the second fly's eye lens.

Or, in this configuration, the illuminating device may comprise a tube-shaped or stick-shaped optical integrator on the specific optical path.

In the illuminating devices of such the configurations, each light source may emit light in the same one color (hereinafter, referred to as a second configuration in this section). Or, each light source may emit light in white or light of respective colors to be the light in white (hereinafter, referred to as a third configuration in this section).

Moreover, a projection type video display according to the present invention comprises a plurality of illuminating devices each of which emits light in different color. At least one of the illuminating devices is the illuminating device according to the second configuration, light of respective colors emitted from the respective illuminating devices is optically modulated by each display panel, and the modulated light of respective colors is combined and projected.

Furthermore, a projection type video display according to the present invention comprises a plurality of illuminating devices each of which emits light in different color. At least one of the illuminating devices is the illuminating device according to the second configuration, light of respective colors emitted from the respective illuminating devices is guided in the same direction and optically modulated by a single display panel, and the modulated light is projected.

Furthermore, a projection type video display according to the present invention comprises the illuminating device according to the third configuration. Light in white emitted from the illuminating device is optically modulated by a single display panel and the modulated light is projected.

Furthermore, a projection type video display according to the present invention comprises the illuminating device according to the third configuration. Light in white emitted from the illuminating device is separated into light in red, light in green, light in blue, light of respective colors is optically modulated by each display panel, and the modulated light of respective colors is combined and projected.

Moreover, in the first configuration, the illuminating device comprises a first polarization conversion system for converting light emitted from a first light source out of the plurality of light sources into polarized light of a first polarizing direction, and a second polarization conversion system for converting light emitted from a second light source different from the first light source into polarized light of a second polarizing direction perpendicular to the first polarizing direction. The optical path changing means guides the light emitted from the first light source and converted into the polarized light of the first polarizing direction to a specific optical path by one of the two functions, transmission and reflection, and guides the light emitted from the second light source and converted into the polarized light of the second polarizing direction to the specific optical path by the other of the two function, the transmission and the reflection (hereinafter, referred to as a fourth configuration in this section).

Such the fourth configuration is a configuration utilizing the transmission and the reflection based on a difference of the polarized light, and a light amount is increased further in a case where the solid light-emitting elements are allowed to emit pulses of light by passing a large amount of electric currents instantaneously than in a case where the solid light-emitting elements are allowed to emit light in a steady-state manner by passing a steady-state current, so that an amount of emitted light in the illuminating device of the fourth configuration is increased.

In the fourth configuration, amounts of the light emitted from the first light source and the light emitted from the second light source may be rendered different each other such that amounts of the polarized light of the first polarizing direction and the polarized light of the second polarizing direction obtained by passing through the optical path changing means are equalized.

In the fourth configuration and configurations depending thereon, an illuminating device may comprise a first fly's eye lens provided on a light-emission side of each light source, and a second fly's eye lens provided on the specific optical path, paired with the first fly's eye lens, and integrating and guiding light to an object to be illuminated. Or, an illuminating device may comprise a tube-shaped or stick-shaped optical integrator on the specific optical path.

In the fourth configuration and configurations depending thereon, an illuminating device may comprise a switching polarized light rotating element for switching between a function state where a polarizing direction of received light is rotated by 90 degrees and a function state where the polarizing direction is not rotated, by on and off of an energization, and a switching circuit for controlling the switching polarized light rotating element. The switching polarized light rotating element is arranged on the specific optical path, the lighting control means performs a lighting control so as to stagger timing of the pulsed emissions of the first light source and the second light source, the switching circuit turns on and off the switching polarized light rotating element in synchronization with timing of the pulsed emission of the solid light-emitting element, and polarizing directions of light obtained by passing through the switching polarized light rotating element are redirected in a common direction (hereinafter, referred to as a fifth configuration in this section).

In the fourth configuration and configurations depending thereon (except for the above-described fifth configuration), each light source may emit light in the same one color (hereinafter, referred to as a sixth configuration in this section). In the fourth configuration and configurations depending thereon (except for the fifth configuration), each light source may emit light in white or light of respective colors to be the light in white (hereinafter, referred to as a seventh configuration in this section).

Furthermore, a projection type video display according to the present invention comprises a plurality of illuminating devices each of which emits light in different color. At least one of the illuminating devices is the illuminating device according to the sixth configuration, light of respective colors emitted from the respective illuminating devices is optically modulated by each display panel, and the modulated light of respective colors is combined and projected.

In addition, a projection type video display according to the present invention comprises a plurality of illuminating devices each of which emits light in different color. At least one of the illuminating devices is the illuminating device according to the sixth configuration, the light of respective colors emitted from the respective illuminating devices is guided in one direction and optically modulated by a single display panel, and the modulated light is projected.

Furthermore, a projection type video display according to the present invention comprises the illuminating device according to the seventh configuration. The light in white or the light of respective colors to be the light in white, emitted from the illuminating device, is optically modulated by a single display panel, and the modulated light is projected.

Furthermore, a projection type video display according to the present invention comprises the illuminating device according to the seventh configuration. Light in white emitted from the illuminating device is separated into light of respectively different colors, the light of respective colors is optically modulated by each display panel, and the modulated light of respective colors is combined and projected.

A projection type video display provided with an illuminating device according to the sixth configuration or the seventh configuration comprises a liquid crystal display panel without a light-incidence side polarizer as the display panel, and a panel driving circuit for driving the liquid crystal display panel. The lighting control means performs a lighting control so as to stagger timing of the pulsed emissions of the first light source and the second light source, and the panel driving circuit, at the time that the polarized light of the first polarizing direction is incident on the liquid crystal display panel, supplies to the liquid crystal display panel one of two video signals, that is, a video signal generated for a liquid crystal panel in which a polarizing direction of incident light crosses a transmitting direction of a light-exit side polarizer and a video signal generated for a liquid crystal panel in which the polarizing direction of incident light is in parallel with the transmitting direction of the light-exit side polarizer, on the other hand, at the time that the polarized light of the second polarizing direction is incident on the liquid crystal display panel, supplies to the liquid crystal display panel the other of the above-mentioned two video signals.

In the fifth configuration, each light source may emit light in the same one color (hereinafter, referred to as an eighth configuration in this section). In the fifth configuration, each light source may emit light in white or light of respective colors to be the light in white (hereinafter, referred to as a ninth configuration in this section).

Furthermore, a projection type video display according to the present invention comprises a plurality of illuminating devices each of which emits light in different color. At least one of the illuminating devices is the illuminating device according to the eighth configuration, light of respective colors from the respective illuminating devices is optically modulated by each display panel, and the modulated light of respective colors is combined and projected.

Furthermore, a projection type video display according to the present invention comprises a plurality of illuminating devices each of which emits light in different color. At least one of the illuminating devices is the illuminating device according to the eighth configuration, light of respective colors emitted from the respective illuminating devices is guided in one direction and optically modulated by a single display panel, and the modulated light is projected.

Furthermore, a projection type video display according to the present invention comprises the illuminating device according to the ninth configuration. The light in white or light of respective colors to be the light in white, emitted from the illuminating device, is optically modulated by a single display panel, and the modulated light is projected.

Furthermore, a projection type video display according to the present invention comprises the illuminating device according to the ninth configuration. Light in white is separated into light of respectively different colors, the light of respective colors is optically modulated by each display panel, and the modulated light of respective colors is combined and projected.

These projection type video displays provided with the illuminating device according to the eighth configuration or the ninth configuration may comprise a liquid crystal display panel as the display panel.

In a projection type video display provided with the illuminating device according to the fourth configuration, the fifth configuration, the sixth configuration, the seventh configuration, the eighth configuration, or the ninth configuration, a level of a video signal supplied to the display panel in receiving polarized light of a first polarizing direction and a level of a video signal supplied to the display panel in receiving polarized light of a second polarizing direction may be rendered different each other. In addition, in these illuminating devices or projection type video displays, it is preferable that the optical path changing means is a polarizing beam splitter made of glass in a cubic shape.

As described above, according to the present invention, the illuminating device has a plurality of light sources formed of one or a plurality of solid light-emitting elements, and the solid light-emitting element is allowed to emit pulses of light. Accordingly, it is possible to totally increase light amount compared to a case in which a solid light-emitting element is allowed to emit light in a steady-state manner. As a result, it is possible to render a substantial light-emitting area smaller than the object to be illuminated, so that the parallelism of the light fluxes guided to the object to be illuminated can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a descriptive diagram showing a projection type video display of a first embodiment;

FIG. 2A is a descriptive diagram showing an illuminating device used in the projection type video display shown in FIG. 1;

FIG. 2B is a descriptive diagram showing a control of pulsed emissions;

FIG. 3A is a descriptive diagram showing another projection type video display of the first embodiment;

FIG. 3B is a descriptive diagram showing an example of crosswise arrangement of two time-division switching mirrors;

FIG. 4 is a descriptive diagram showing another projection type video display of the first embodiment;

FIG. 5 is a descriptive diagram showing another projection type video display of the first embodiment;

FIG. 6 is a descriptive diagram showing another example of the illuminating device of the first embodiment;

FIG. 7A is a descriptive diagram showing another example of the illuminating device of the first embodiment;

FIG. 7B is a descriptive diagram showing a rotary division mirror;

FIG. 8A is a descriptive diagram showing another example of the illuminating device of the first embodiment and is a descriptive diagram showing a state where a light source 12A emits pulses of light;

FIG. 8B is a descriptive diagram showing a state where a light source 12A emits pulses of light;

FIG. 9A is a descriptive diagram showing another example of the illuminating device of the first embodiment;

FIG. 9B is a descriptive diagram showing a mirror device;

FIG. 10 is a descriptive diagram showing another example of the illuminating device of the first embodiment;

FIG. 11 is a descriptive diagram showing another example of the illuminating device of the first embodiment;

FIG. 12 is a descriptive diagram showing an illuminating device of a second embodiment;

FIG. 13 is a front view of a light source used for the illuminating device shown in FIG. 12;

FIG. 14 is a side view of the light source and a polarization conversion system used for the illuminating device shown in FIG. 12;

FIG. 15 is a descriptive diagram showing timing of pulsed emissions of the two light sources of the illuminating device shown in FIG. 12;

FIG. 16 is a descriptive diagram showing a projection type video display using the illuminating device shown in FIG. 12;

FIG. 17 is a descriptive diagram showing an illuminating device having a a-cell and a projection type video display using the illuminating device;

FIG. 18 is a descriptive diagram showing timing of pulsed emissions of the two light sources of the illuminating device and switching timing of the π-cell;

FIG. 19 is a descriptive diagram showing a projection type video display using the illuminating device shown in FIG. 12;

FIG. 20 is a descriptive diagram showing a general normally-white-type liquid crystal display panel;

FIG. 21 is a descriptive diagram showing a projection type video display using the illuminating device shown in FIG. 17; and

FIG. 22 is a descriptive diagram showing another example of a light source of the second embodiment.

### DESCRIPTION OF THE PREFERRED EMBODIMENTS

### Embodiment 1

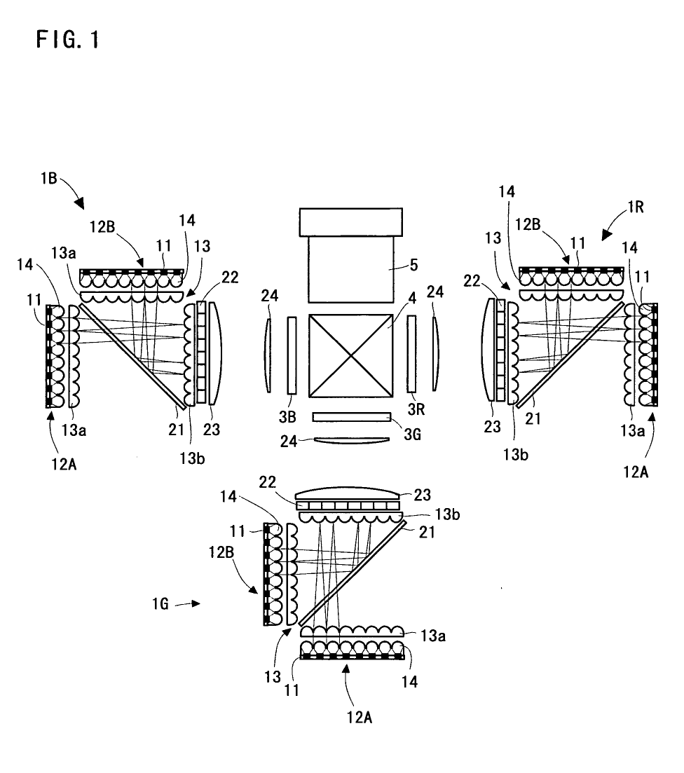

Hereinafter, a projection type video display of a first embodiment of the present invention will be described on the basis of FIGS. 1 to 11. It is noted that, in every example of the embodiment 1, light from a plurality of light sources is guided to the same optical path. However, a configuration in which a difference in wavelength of light is utilized (for example, a configuration in which a dichroic mirror, etc. are used) and a configuration in which a difference in polarization (for example, a configuration in which light is combined by utilizing transmission of P-polarized light and reflection of S-polarized light) are not adopted. That is, a configuration in which light sources that emit light of the same quality in view of color and polarization are used as respective light sources is realized.

FIG. 1 is a diagram showing an optical system of a three-panel projection type video display. The projection type video display comprises three illuminating devices 1R, 1G, and 1B (hereinafter, a numeral “1” is used when generally referring to the illuminating device). The illuminating device 1R emits light in red, the illuminating device 1G emits light in green, and the illuminating device 1B emits light in blue. The light emitted from each illuminating device 1 is guided to respective colors-use liquid crystal display panels 3R, 3G, and 3B (hereinafter, a numeral “3” is used when generally referring to the liquid crystal display panel) by condenser lenses 23, 24. Each liquid crystal display panel 3 is formed of being provided with a light-incidence-side polarizer, a panel portion formed by sealing a liquid crystal between a pair of glass plates (in which a pixel electrode and an alignment film are formed), and a light-exit-side polarizer. Modulated light (image light of respective colors) modulated as a result of passing through the liquid crystal display panels 3R, 3G, and 3B is combined by a cross dichroic prism 4, and rendered full-color image light. The full-color image light is projected by a projection lens 5, and displayed on a screen.

The illuminating device 1 is provided with a first light source 12A in which LED chips 11 . . . are arranged in an array shape and lens cells 14 . . . are arranged on a light-emission side of each of the LED chips 11, and a second light source 12B in which LED chips 11 . . . are arranged in an array shape and lens cells 14 . . . are arranged on a light-emission side of each of the LED chips 11 (hereinafter, a numeral “12” is used when generally referring to the light source). The two light sources 12 of each illuminating device 1 are arranged such that main light-emission optical axes thereof are perpendicular to each other. Moreover, a time-division switching mirror 21 is provided at a crossing position of the main light-emission optical axes. The time-division switching mirror 21 is arranged obliquely by 45 degrees to each of the main light-emission optical axes of the two light sources.

Furthermore, each illuminating device 1 is provided with an integrator lens 13 for integrating and guiding light emitted from each LED chip 11 and collimated by the lens cell 14 to the liquid crystal display panel 3. A first fly's eye lens 13a of the integrator lens 13 is arranged at a light-emission side of each light source 12. In addition, a second fly's eye lens 13b of the integrator lens 13 is arranged at a rear side (light-exit side) of the time-division switching mirror 21. Each pair of lenses of the fly's eye lenses 13a, 13b guides the light emitted from each LED chip 11 to an entire surface of the liquid crystal display panel 3. The LED chips 11 . . . are molded by a transparent resin, and as a result the transparent resin being formed in a convex shape, the lens cells 14 . . . are formed. The LED chips 11 and the lens cells 14 may be in a round shape. However, in this embodiment, the LED chips 11 and the lens cells 14 are formed in a square shape, and moreover, aspect ratios thereof coincide with that of the liquid crystal display panel 3.

A polarization conversion system 22 is provided on the light-exit side of the fly's eye lens 13b. The polarization conversion system 22 is structured of a polarization beam splitter array (hereinafter, referred to as a PBS array). The PBS array is provided with a polarized light separating surface and a retardation plate (½ λ plate). Each polarized light separating surface of the PBS array transmits P-polarized light, for example, out of light from the integrator lens 13, and changes an optical path of S-polarized light by 90 degrees. The S-polarized light having the optical path changed is reflected by an adjacent polarized light separating surface, converted into the P-polarized light by the retardation plate provided on a front side (light-exit side) of the polarized light separating surface, and given off therefrom. On the other hand, the P-polarized light that passes through the polarized light separating surface is given off as it is. That is, in this case, approximately all the light is converted into the P-polarized light. In the above-described example, a configuration in which all the light is converted into the P-polarized light is described. However, a configuration in which all the light is converted into the S-polarized light by providing the retardation plate at a position where the P-polarized light is given off may be adopted.

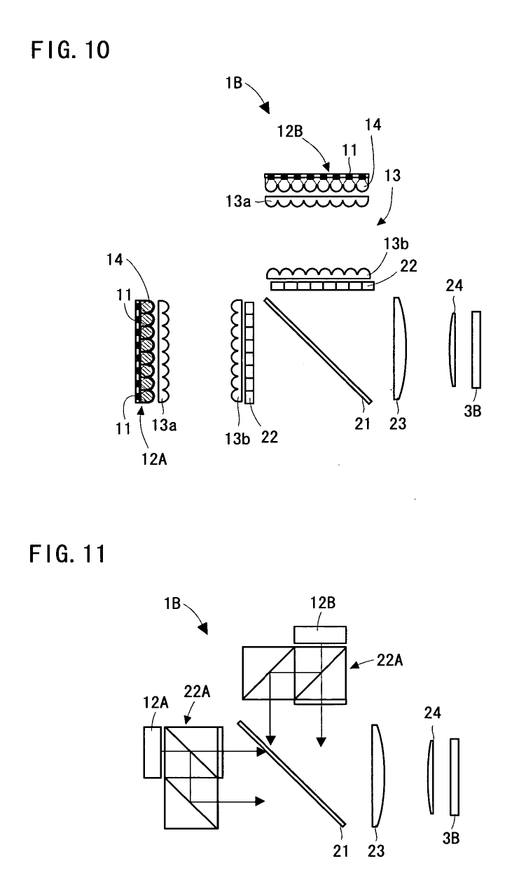

As the time-division switching mirror 21 may be structured by using the DigiLens (a registered trademark) which is a switching diffraction element, for example, (Published Japanese translations of PCT international publication for patent applications No. 2002-520648 (see paragraph [0008] and [0009], in particular), and Published Japanese translations of PCT international publication for patent applications No. 2002-525646). It is noted that, if the switching diffraction element is suitable for the P-polarized light, for example, as shown in FIG. 10, it may be configured such that light is redirected in a direction of the P-polarized light at a stage before the light is incident on the time-division switching mirror 21. In this example of FIG. 10, each light source 12 is provided with the second fly's eye lens 13b and the polarization conversion system 22. FIG. 11 also shows a configuration example in which light is redirected in the direction of the P-polarized light at a stage before the light is incident on the time-division switching mirror 21. This will be described later.

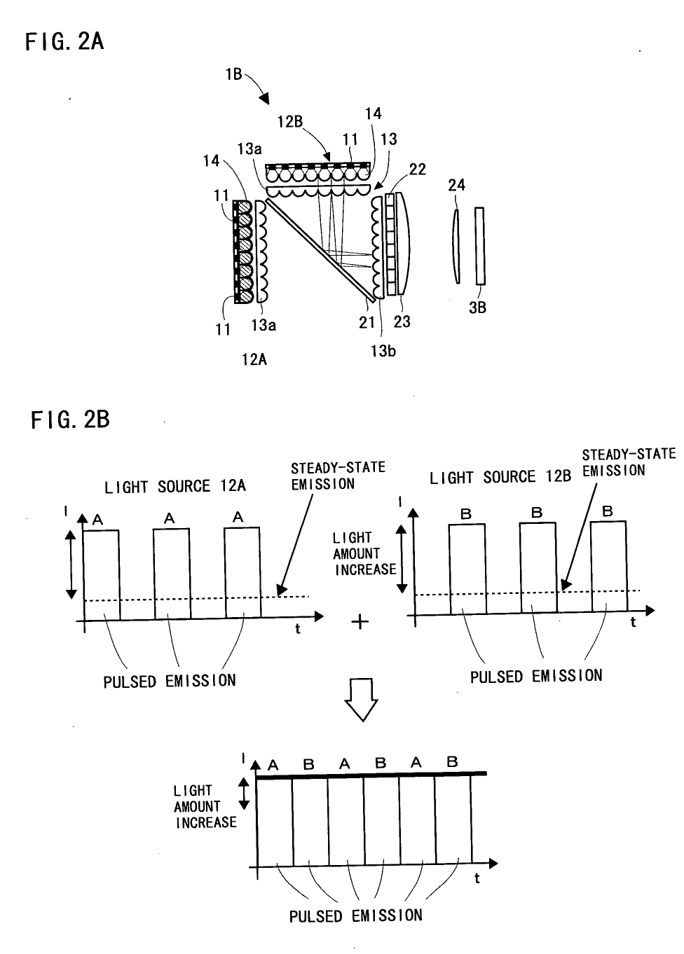

A light source lighting control part, not shown, allows the first light source 12A and the second light source 12B to alternately emit pulses of light in each illuminating device 1. FIG. 2A shows a state where the first light source 12A is extinguished and the second light source 12B is lighted in a blue color-use illuminating device 1B. The pulsed emission is a method of supplying a large amount of electric currents to the LED chips 11 in a short time period, and a light-emitting amount increases compared to a steady-state light emission of the LED chips 11. However, a predetermined interval is required between a pulsed emission of one light source and a next pulsed emission of the same light source. In order to bridge the interval, as shown in FIG. 2B, it is configured such that the first light source 12A and the second light source 12B alternately emit pulses of light. In addition, the time-division switching mirror 21 is energized by a driving part, not shown, so as to become a transmitting state when the first light source 12A is lighted, and become a reflecting state when the second light source 12B is lighted. In FIG. 2A, the blue color-use illuminating device 1B is shown, and however, in other colors-use illuminating devices, two light sources 12 alternately emit pulses of light.

As described above, the LED chips 11 are allowed to sequentially emit pulses of light, so that it is possible to totally increase the light amount compared to a case in which a plurality of solid light-emitting elements are allowed to emit light in a steady-state manner. In addition, a plurality of light sources 12 are respectively directed in different directions, and the time-division switching mirror 21 (optical path changing means) is provided. As a result, a substantial light-emitting area is smaller than the object to be illuminated, so that it is possible to improve a parallelism of light fluxes guided to the object to be illuminated. In other words, it is possible to downsize the projection type video display by shortening a distance between the condenser lenses 23, 24. Moreover, it is possible to utilize a light source that emits light of equal quality in view of color and polarization as each light source.

It is noted that each light source 12 is composed of a plurality of LEDs in the example above, however it is not always the case, and it is possible that the light source 12 is composed of one LED. Much the same is true on the light source 12 used in the illuminating device 1 exemplified below.

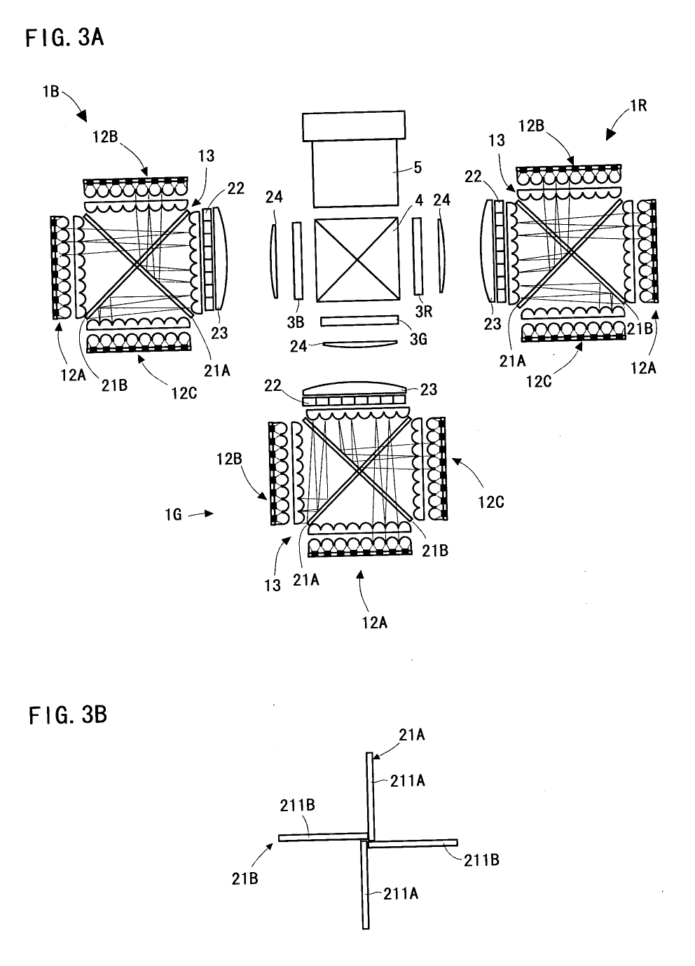

FIG. 3A shows a configuration example in which each illuminating device 1 is composed of three light sources 12 (wavelength bands of light emitted from the three light sources of each illuminating device are approximately the same). That is, each illuminating device 1 is formed by arranging a first light source 12A, a second light source 12B, and a third light source 12C in almost a “U” shape (a quasi-square shape in which one of four sides is missing), and has a configuration in which two time-division switching mirrors 21A, 21B are arranged crosswise. In such the configuration, the first light source 12A, the second light source 12B, and the third light source 12C are allowed to sequentially emit pulses of light. In addition, when the first light source 12A is lighted, both of the two time-division switching mirrors 21A, 21B become the transmitting state. When the second light source 12B is lighted, the time-division switching mirror 21A becomes the reflecting state and the time-division switching mirror 21B becomes the transmitting state. When the third light source 12C is lighted, the time-division switching mirror 21A becomes the transmitting state and the time-division switching mirror 21B becomes the reflecting state.

FIG. 3B shows an example of crosswise arrangement of two time-division switching mirrors 21A, 21B. Each of the time-division switching mirrors 21A, 21B arranged crosswise is composed of two mirrors (four in total: 211A, 211A, 211B, 211B). It is structured that these four time-division switching mirrors are arranged crosswise in such a manner as to bring respective corner sides into close contact. Needless to say, the present invention is not limited to such the structure. That is, the crosswise arrangement may be realized in such a manner that one of the two time-division switching mirrors has single-piece structure and the other has two-piece structure.

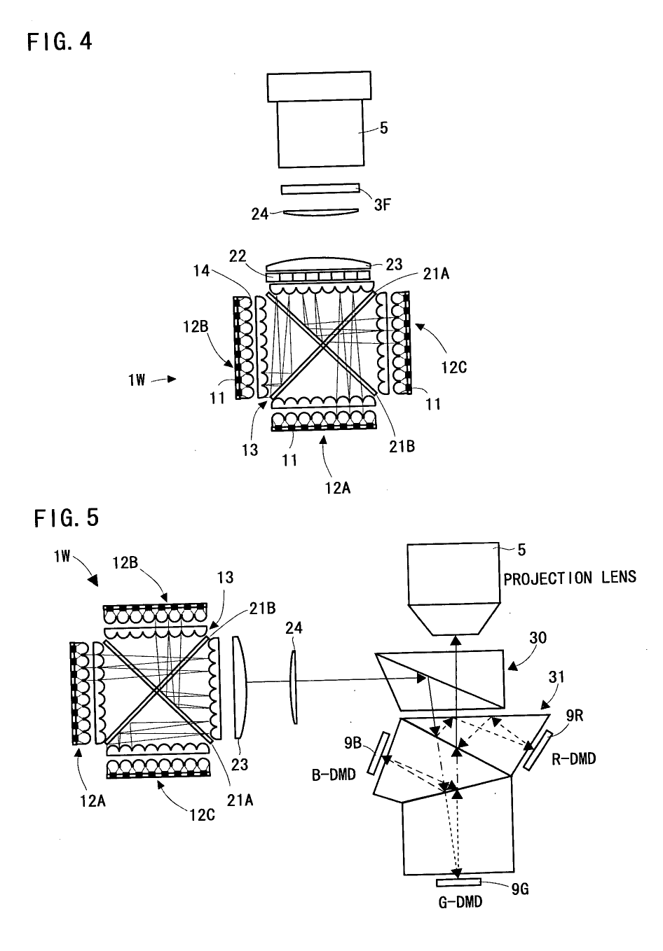

FIG. 4 shows a single-panel projection type video display. An illuminating device 1W is formed by arranging a first light source 12A, a second light source 12B, and a third light source 12C in almost a “U” shape (a quasi-square shape in which one of four sides is missing), and has a configuration in which two time-division switching mirrors 21A, 21B are arranged crosswise. All the three light sources 12 emit light in white. All the LED chips of each light source 12 may emit light in white. Or, light in white may be emitted by arranging the LED chip 11 that emits light in red, the LED chip 11 that emits light in green, and the LED chip 11 that emits light in blue in a mixed manner. The first light source 12A, the second light source 12B, and the third light source 12C are allowed to sequentially emit pulses of light. In addition, when the first light source 12A is lighted, both of the two time-division switching mirrors 21A, 21B become the transmitting state. When the second light source 12B is lighted, the time-division switching mirror 21A becomes the reflecting state, and the time-division switching mirror 21B becomes the transmitting state. When the third light source 12C is lighted, the time-division switching mirror 21A becomes the transmitting state, and the time-division switching mirror 21B becomes the reflecting state. The light in white emitted from the illuminating device 1W is incident on a transmission type liquid crystal display panel 3F provided with a RGB color filter and optically modulated.

It is noted that the projection type video display may be provided with an illuminating device 1R, an illuminating device 1G, and an illuminating device 1B, light of respective colors from each illuminating device 1 may be guided in a single direction using a dichroic mirror, etc., and optically modulated by a single display panel. In this case, the illuminating device 1R, the illuminating device 1B, and the illuminating device 1B are lighted sequentially and a red color-use image, a green color-use image, and a blue color-use image may be displayed sequentially on the single display panel.

FIG. 5 shows a projection type video display using three pieces of reflection type display elements. The projection type video display of this configuration is also provided with the illuminating device 1W. The light in white emitted from the illuminating device 1W is guided to a total internal reflection (TIR) prism 30 via a lens 23. The light in white reflected by the total internal reflection prism 30 is guided to a color separating/mixing prism 31 composed of three prisms. Then, light of respective colors is guided to respective colors-use DMDs (Digital Micro-mirror Devices) 9R, 9G, and 9B. Reflected light (image light of respective colors) therefrom is incident on the color separating/mixing prism 31 again, and given off from the color separating/mixing prism 31 after becoming full-color image light. The full-color image light given off from the color separating/mixing prism 31 passes through the total internal reflection prism 30 and is projected by a projection lens 5.

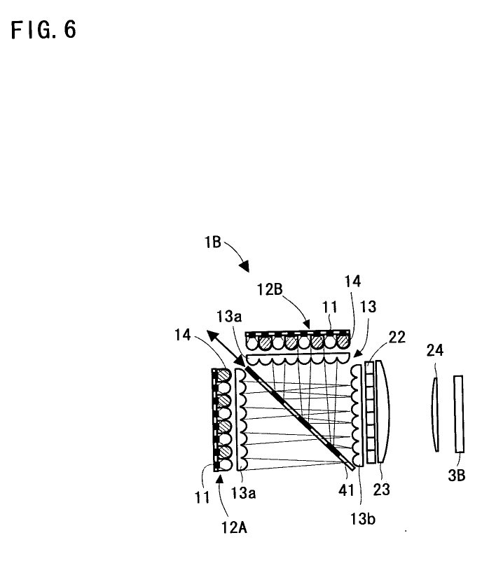

FIG. 6 shows another configuration example of the illuminating device 1 (herein, the illuminating device 1B that emits light in blue is exemplified). In this configuration example, a reciprocating driving mirror 41 is provided instead of the time-division switching mirror 21. The reciprocating driving mirror 41 is formed in such a manner that reflecting regions and transmitting regions are formed alternately in a striped shape in a plane surface and is so provided as to slide reciprocatively in a direction indicated by arrows in the FIG. 6. The reflecting regions and the transmitting regions are formed corresponding to the number of columns of the LED chips 11 constituting the light source 12, for example. The pulsed emission of each light source 12 is performed not by all the LED chips 11 of the light source 12 but by a column of LED chips. In this embodiment, the LED chips on every other column emit pulses of light. In the two light sources 12, the columns on which the LED chips emit pulses of light are set in such a manner as to have an interpolating relationship one another. In a state where the LED chips 11 on the uppermost column of the light source 12A in FIG. 6 are extinguished, for example, the LED chips 11 on the leftmost column (which has the interpolating relationship with the above-mentioned column of the light source 12A) of the light source 12B in FIG. 6, are lighted. In addition, in this state, the reflecting region of the reciprocating driving mirror 41 is located on an optical axis of the LED chips 11 on the uppermost column of the light source 12A in FIG. 6 (also on an optical axis of the LED chips 11 on the leftmost column of the light source 12B in FIG. 6), and light emitted from the LED chips 11 on the leftmost column of the light source 12B in FIG. 6 is guided to a fly's eye lens 13b. That is, in the light source 12A, in a case where the transmitting region of the reciprocating driving mirror 41 is located on the optical axis of the LED chips 11, the LED chips 11 having the optical axis on which the transmitting region is located emit pulses of light. Accordingly, other LED chips 11 having the optical axis on which the transmitting region is not located, become an extinguished state. On the other hand, in the light source 12B, in a case where the reflecting region of the reciprocating driving mirror 41 is located on the optical axis of the LED chips 11, the LED chips 11 having optical axis on which the reflecting region is located emit pulses of light. Accordingly, other LED chips 11 having optical axis on which the reflecting region is not located become the extinguished state.

It is noted that the reciprocating driving mirror 41 is driven in the directions indicated by arrows in FIG. 6. However, the reciprocating driving mirror 41 may be driven in other directions. The reciprocating driving mirror 41 may be driven in a direction, in and out of the page of FIG. 6, for example. In this case, each light source 12 may emit pulses of light by each row. In addition, the reflecting regions and the transmitting regions may be formed corresponding to the rows.

Furthermore, in a configuration in which the time-division switching mirror (see FIG. 1 and others) is used, the time-division switching mirror may switch between the reflecting regions and the transmitting regions in a stripe shape, and it is possible that each light source 12 emits pulses of light by each row or by each column.

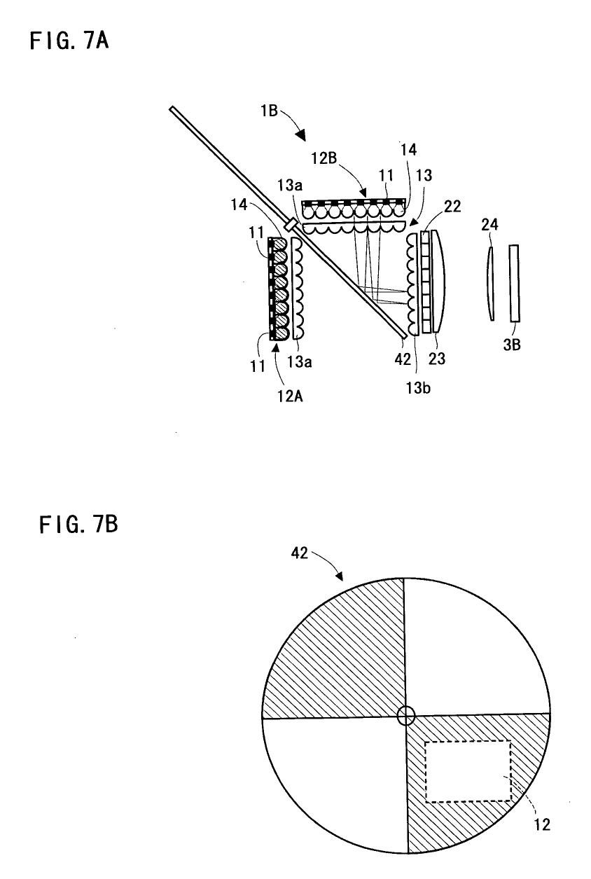

FIG. 7 shows another configuration example of the illuminating device 1 (herein, an illuminating device 1B that emits light in blue is exemplified). In this configuration example, a rotary division mirror 42 is provided instead of the time-division switching mirror 21. The rotary division mirror 42 has a circular disk surface arranged at a crossing position of light emitted from the light source 12A and light emitted from the light source 12B, and a rotating center provided at a position deviated from the crossing position. The circular disk surface, as shown in FIG. 7B, is divided into four regions in total, in which the reflecting region (indicated by diagonal lines) and the transmitting region are formed alternately. The rotation of the rotary division mirror 42 is synchronized with the pulsed emission of the light source 12. More specifically, a synchronous rotating control is performed such that the transmitting region is located at the crossing position when the light source 12A emits pulses of light, and the reflecting region is located at the crossing position when the light source 12B emits pulses of light.

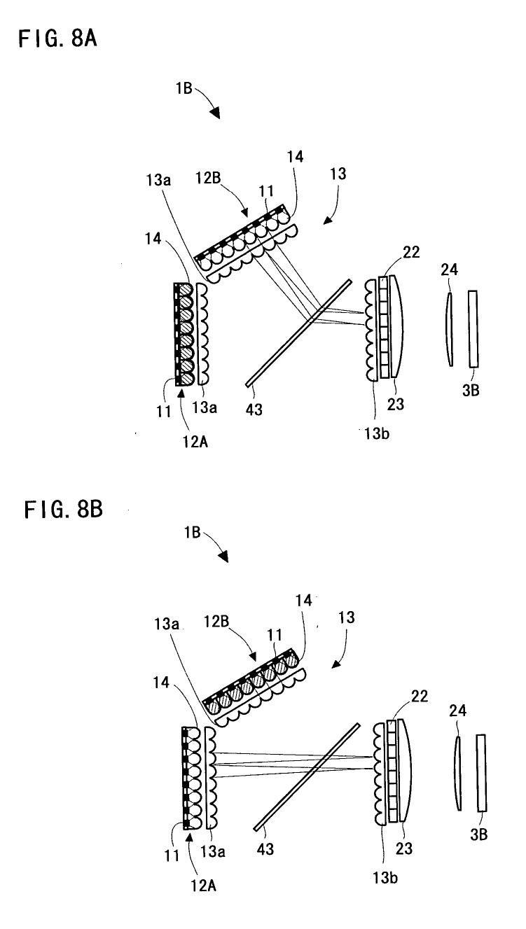

FIG. 8 shows another configuration example of the illuminating device 1 (herein, an illuminating device 1B that emits light in blue is exemplified). In this configuration example, a switching diffraction element 43 (for example, the element is formed of the aforementioned Digilens (the registered trademark)) instead of the time-division switching mirror 21. The switching diffraction element 43 changes an advancing direction of light by diffraction according to an energization control synchronous with the pulsed emission in the light source 12B. That is, when the LED chips 11 of the light source 12B emit pulses of light, as shown in FIG. 8A, the switching diffraction element 43 diffracts light and guides the light to a second fly's eye lens 13b. When the LED chips 11 of the light source 12A emit pulses of light, as shown in FIG. 8B, the switching diffraction element 43 allows light to advance straight and guides the light to the second fly's eye lens 13b.

In the configuration shown in FIG. 8, two light sources 12A, 12B are provided, however, a configuration, in which three light sources are provided, and the switching diffraction elements 43 are arranged crosswise at a crossing position of light emitted from the three light sources, may be adopted. It is noted that, if the switching diffraction element 43 is suitable for the P-polarized light, for example, light may be redirected into a direction of the P-polarized light at a stage before the light is incident on the switching diffraction element 43 (see FIG. 10).

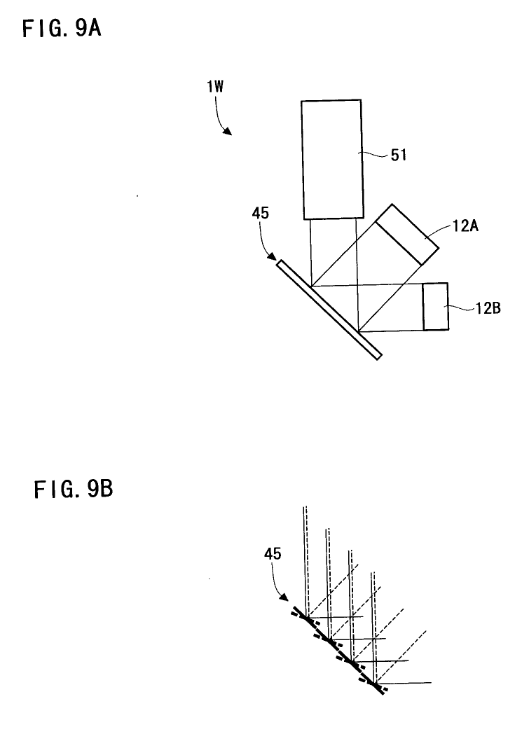

FIG. 9A shows another configuration example of the illuminating device 1 (herein, an illuminating device 1W that emits light in white is shown). In this configuration example, the illuminating device 1 is provided with two light sources 12A, 12B, and the two light sources are arranged such that light-emitting optical axes intersect at an angle of 45 degrees. Each light source 12 is formed by being provided with one or a plurality of white LED chips. In this embodiment, the LED chip has photonic crystal structure, and light-emission direction is approximately vertical to a light-emitting surface, therefore high in directionality. In addition, in a case that the light source 12 is configured of a plurality of photonic crystal-type LED chips, intervals between the LED chips can be rendered as narrow as possible. It is noted that the photonic crystal is a man-made crystal in which a dielectric constant is modulated periodically.

A micro mirror device 45 is provided at a crossing position of optical axes of the two light sources 12. The micro mirror device 45 is arranged at an angle of 45 degrees with the optical axis of the light source 12B and at an angle of 90 degrees with the optical axis of the light source 12A. The micro mirror device 45 is formed of a number of micro mirrors. At a time of OFF-energization, as shown in FIG. 9B, each micro mirror is obliquely positioned at 45 degrees (see heavy solid lines in FIG. 9B) with the optical axis (indicated by solid lines in FIG. 9B) of the light source 12B. On the other hand, at a time of ON-energization, each micro mirror is tilted counterclockwise at 22.5 degrees (see heavy dotted lines). The energization to the micro mirror device 45 is turned off when the light source 12B emits pulses of light, and the energization to the micro mirror device 45 is turned on when the light source 12A emits pulses of light. As a result, light emitted from both of the two light sources 12 is guided to a specific optical path (the same optical path). It is noted that, preferably, luminance (the luminance of light flux after having been reflected by the micro mirror device 45) by the light source 12A and luminance (the luminance of light flux after having been reflected by the micro mirror device 45) by the light source 12B are rendered same.

A rod integrator 51 (may be a hollow member of which inner surface is a mirror surface) formed of a glass pole is provided on the specific optical path. As a result of light passing through the rod integrator 51 with being reflected, a parallelism of the light flux is improved, and it is possible to obtain a surface light source having a uniform brightness.

It is noted that the light source 12A and the light source 12B are arranged such that light-emitting optical axes intersect at an angle of 45 degrees in the configuration in FIG. 9. However, another arrangement may also be adopted. If the angle is rendered smaller (if the arrangement of the light source 12A and the light source 12B is rendered closer to parallel arrangement), it is possible to render small an oscillation angle (rotation angle) of each micro mirror of the micro mirror device 45 at the time that the energization is on or off.

The illuminating device 1W in the above-described FIG. 9 can be used for the projection type video displays shown in FIG. 4 and FIG. 5. Needless to say, also in the configuration shown in FIG. 9, an illuminating device 1R that emits light in red, an illuminating device 1G that emits light in green, and an illuminating device 11B that emits light in blue may be provided. In addition, it may be also configured that a projection type video display is provided with the three illuminating devices 1R, 1G, and 1B (see FIG. 1, and others).

It is noted that the digital micro mirror device (DMD) drives each micro mirror individually in order to display an image. However, the micro mirror device 45 may be configured to drive all the micro mirrors all together. In addition, the micro mirror device 45 may be configured to drive each micro mirror by a piezoelectric element and others.

An integrator lens formed of a pair of fly's eye lenses may be provided on a light-exit side of the rod integrator 51 shown in FIG. 9. Thus, in a case of providing the integrator lens, it is preferable to provide a polarization conversion system 22. In addition, the polarization conversion system may be provided directly on the light-exit side of the rod integrator 51. The polarization conversion system in this case may be formed of two polarizing beam splitters (PBSs) and a retardation plate (½ λ plate) arranged on the light-exit side of one of the two polarizing beam splitters (see a polarization conversion system 22A in FIG. 11 described later). A size of a light-incidence surface of one polarizing beam splitter coincides with a size of the light-exit surface of the rod integrator 51. Moreover, it is preferable that an aspect ratio of a light-exit surface of the whole polarization conversion system coincides with an aspect ratio of a video display panel. Regardless of the configuration of FIG. 9, it is preferable that aspect ratios of each LED chip, each light source, each illuminating device, the rod integrator, and the integrator lens coincide with an aspect ratio of the video display panel. Furthermore, a solid light-emitting element is not limited to the LED.

An illuminating device 1B shown in FIG. 10, as described above, has the configuration in which the polarizing directions are redirected into a common direction in each light source 12.

An illuminating device 1B shown in FIG. 11, too, has the configuration in which the polarizing directions are redirected into a common direction in each light source 12. In this configuration example, the illuminating device 1 is provided with two light sources 12A, 12B. The LED chips in the light source 12 have photonic crystal structure, and a light-emission direction is approximately vertical to a light-emitting surface, therefore high in directionality. The polarization conversion system 22A is provided on the light-emission side of each light source 12. The polarization conversion system 22A is formed of two polarizing beam splitters (PBSS) and a retardation plate (½ λ plate) arranged on the light-exit side of one of the two polarizing beam splitters. A size of a light-incidence surface of one polarizing beam splitter coincides with a size of a light-exit surface of the light source 12.

### Embodiment 2

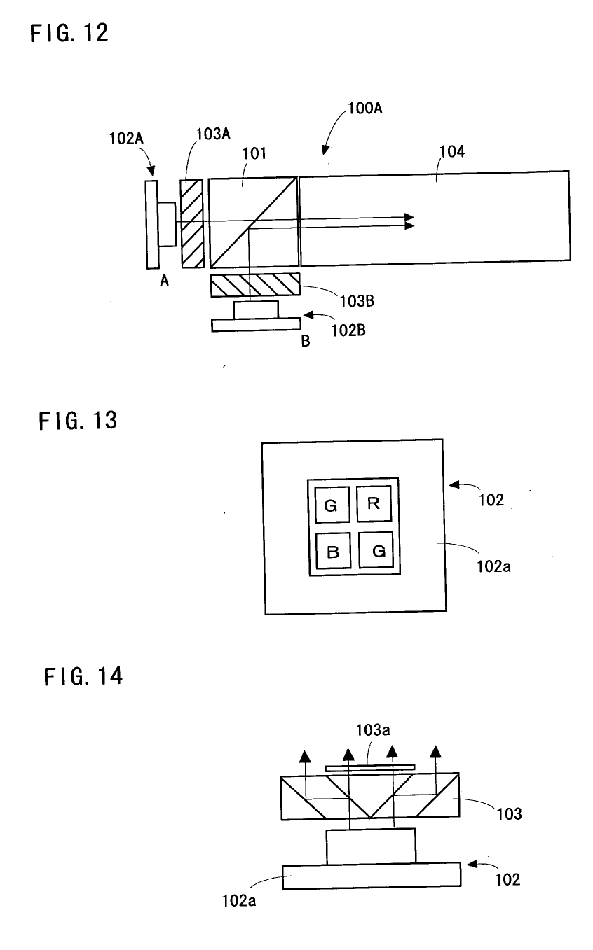

Hereinafter, an illuminating device and a projection type video display according to a second embodiment of the present invention will be described on the basis of FIGS. 12 to 22.

FIG. 12 is a descriptive diagram showing an illuminating device 100A. A first light source 102 (hereinafter, a numeral 102A is added in some cases) and a first polarization conversion system 103 (hereinafter, a numeral 103A is added in some cases) are arranged on a first light-incidence surface of a polarized light mixing element (optical path changing means) 101, and a second light source 102 (hereinafter, a numeral 102B is added in some cases) and a second polarization conversion system 103 (hereinafter, a numeral 103B is added in some cases) are arranged on a second light-incidence surface of the polarized light mixing element 101. The first light-incidence surface and the second light-incidence surface cross each other at 90 degrees. In addition, a polarized light mixing surface (a polarized light separating surface) of the polarized light mixing element 101 is arranged obliquely by 45 degrees to each of main light-emission optical axes of the two light sources 102. Furthermore, a rod integrator 104 is arranged on a light-exit surface (this light-exit surface faces the first light-incidence surface) of the polarized light mixing element 101. As the polarized light mixing element 101, a so-called wire grid polarizer can be used. However, in this embodiment, a polarizing beam splitter made of glass in a cubic shape is used. If this polarized beam splitter made of glass in the cubic shape is used, it is possible to expect a total internal reflection on the polarized light mixing surface, so that it is possible to shorten a length of the rod integrator 104. The rod integrator 104 may be glued by a transparent adhesive (having a refractive index equal to or not equal to a refractive index of glass constituting the rod integrator 104 and the polarized light mixing element 101, and the like). Moreover, at least the light-exit surface of the rod integrator 104 is formed in a square shape, and furthermore, an aspect ratio of the square-shaped light-exit surface approximately coincides with an aspect ratio of a video display element.

The light source 102 is a light source that emits light in white or light of respective colors to be the light in white, and as shown in FIG. 13, has a configuration in which four LED chips are arranged in the same plane surface, for example. In this example, one of the four LED chips emits light in red, another emits light in blue, and the remaining two emit light in green. The two LED chips that emit light in green are arranged diagonally. The above-described four LED chips are arranged on a heatsink 102a. The LED chips may have the photonic crystal structure.

The polarization conversion system 103, as shown also in FIG. 14, is configured of a polarizing beam splitter array (hereinafter, referred to as a PBS array). Each polarized light separating surface of the PBS array transmits P-polarized light, for example, out of light from the light source 102 and changes an optical path of S-polarized light by 90 degrees. The S-polarized light having the optical path changed is reflected by an adjacent polarized light separating surface (or a reflecting surface), and is given off as it is. On the other hand, the P-polarized light that passes through the polarized light separating surface is converted into the S-polarized light by the retardation plate (½ λ plate) 103a provided on a front side (on the light-exit side) of the polarized light separating surface, and is given off. That is, in this case, approximately all light is converted into the S-polarized light. It is noted that the polarizing beam splitter is configured of a so-called wire grid polarizer and a polarized light separating multilayered surface.

Herein, a first polarization conversion system 103 is so arranged that light that is to be the P-polarized light for the polarized light mixing surface (polarized light separating surface) of the polarized light mixing element 101 is supplied from the first light source 102A. Similarly, a second polarization conversion system 103B is so arranged that light that is to be the S-polarized light for the polarized light mixing surface (polarized light separating surface) is supplied from the first light source 102B.

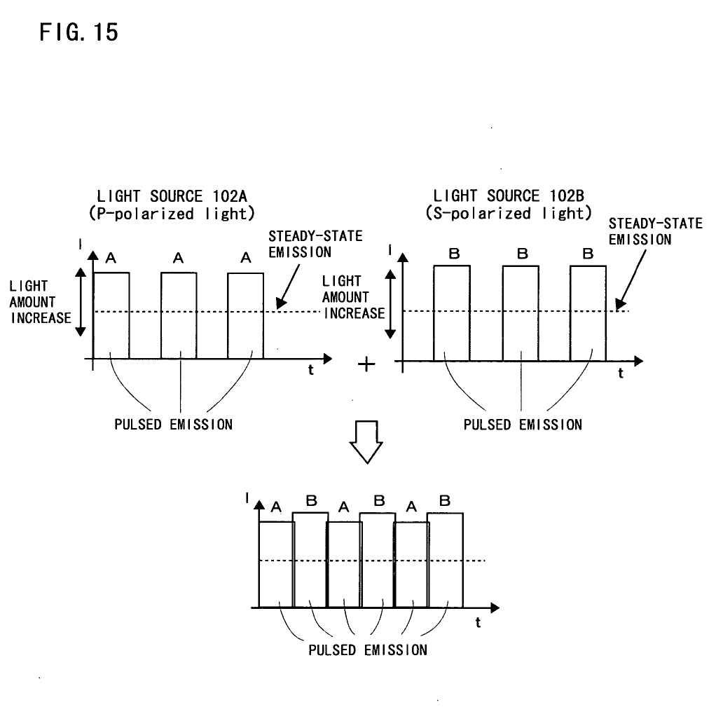

A LED lighting control circuit, not shown, allows the first light source 102A and the second light source 102B in the illuminating device 100A to alternately emit pulses of light. FIG. 15 shows a lighted state and an extinguished state of the first light source 102A and the second light source 102B in the illuminating device 100A. A pulsed emission is a method of supplying a large amount of electric currents to the LED chips in a short time period, and a peak light-emitting amount increases compared to a steady-state emission of the LED chips. However, a predetermined interval is required between the pulsed emission and a next pulsed emission. In order to bridge the interval, the first light source 102A and the second light source 102B are allowed to alternately (phases are shifted by 180 degrees) emit pulses of light.

A frequency of the pulsed emission of each light source 102 is 120 Hz. Accordingly, a period of the pulsed emission (lighting period) of each light source 102 is approximately 8.3 milliseconds (msec). It is noted that, as shown also in FIG. 15, the periods of the pulsed emission of the first light source 102A and the second light source 102B may overlap a little each other. This makes it possible to prevent an instantaneously generated decrease of light amount in the pulsed emission (generating a non light-emitting state between one pulsed emission and the next pulsed emission). Much the same is true on the afore-described first embodiment. It is noted that, an arrangement that polarizing directions of the light emitted from the first light source 102A and the second light source 102B are rendered different by 90 degrees, the position where the retardation plate 103a of the polarization conversion system 103 is provided, and the lighted and extinguished frequency (120 Hz) in the first light source 102A and the second light source 102B are described as an example, and however, it is not limited to the above-described example. Much the same is true on configuration examples below.

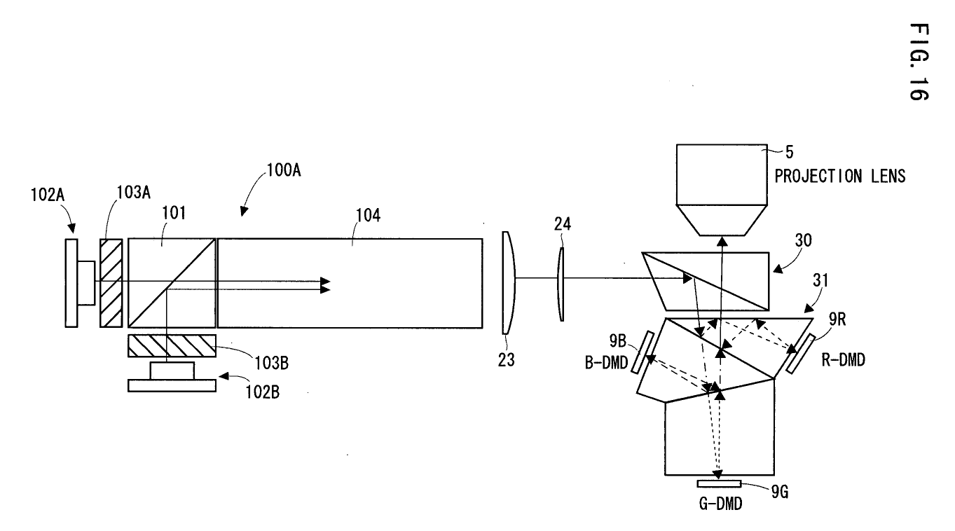

FIG. 16 is a descriptive diagram showing a projection type video display using an illuminating device 100A. The projection type video display uses three reflection type display elements. Light in white emitted from the illuminating device 100A is guided to a total internal reflection (TIR) prism 30 via a lens 23. The light in white reflected by the total internal reflection prism 30 is guided to a color separating/mixing prism 31 formed of three prisms. Furthermore, light of respective colors is guided to respective colors-use DMDs (Digital Micro mirror Device) 9R, 9G, and 9B. Reflected light (image light of respective colors) therefrom is incident on the color separating/mixing prism 31 again, and given off from the color separating/mixing prism 31 after becoming full-color image light. The full-color image light given off from the color separating/mixing prism 31 passes through the total internal reflection prism 30 and is projected by a projection lens 5.

Incidentally, a light amount of the P-polarized light that passes through the polarized light mixing surface (polarized light separating surface) in the polarized light mixing element 101 decreases, compared to a light amount of the S-polarized light that is reflected by the polarized light mixing surface (polarized light separating surface). It is not desirable that such the light amount difference is caused. Therefore, it is preferable to equalize light amounts of the P-polarized light and the S-polarized light guided to the rod integrator 104 by controlling power supplied to the second light source 102B, for example. Or, two light sources 102A, 102B which the same amount of power is supplied to and yet emit a different amount of light may be adopted. Or, such a correction described below may be performed. That is, a luminance signal of a video signal to be supplied when the first light source 102A is lighted is rendered higher than a luminance signal of a video signal to be supplied when the second light source 102B is lighted. In other words, the light amount difference between the P-polarized light and the S-polarized light may be eliminated by processing the video signals. Such the processes can be applied to a configuration example below.

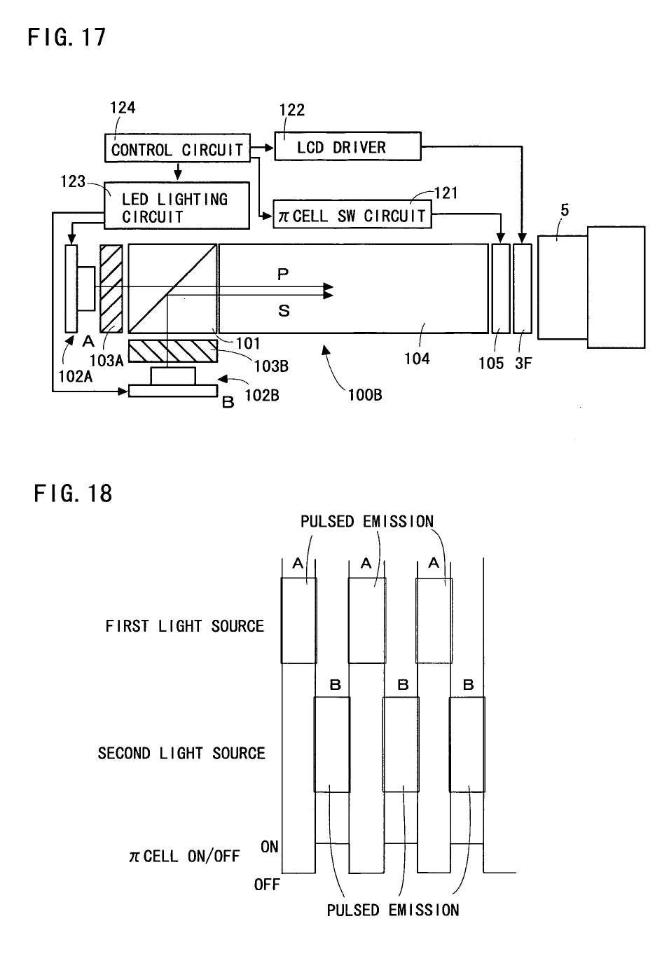

FIG. 17 is a descriptive diagram showing a projection type video display using an illuminating device 100B. The illuminating device 100B is configured such that a π-cell (a switching polarization rotating element) 105 is added to the afore-described illuminating device 100A. The π-cell 105 is arranged on a light-exit side of the rod integrator 104. The π-cell 105 has a configuration equivalent to a configuration in which a polarizer is removed from a liquid crystal display panel, for example, and switches between a function state where a polarizing direction of received light is rotated by 90 degrees and a function state where the polarizing direction is not rotated, by on and off of energization. For example, in a state where the first light source 102A emits pulses of light (a state where the P-polarized light is supplied to the π-cell 105 via the rod integrator 104), power voltage is not applied from a π-cell switch circuit 121 to the π-cell 105 (energization is off). At this time, the π-cell 105 converts the received P-polarized light into the S-polarized light. On the other hand, in a state where the second light source 102B emits pulses of light (a state where the S-polarized light is supplied to the π-cell 105 via the rod integrator 104), power voltage is applied to the π-cell 105 (energization is on). At this time, the π-cell 105 transmits the received S-polarized light as it is. That is, the P-polarized light from the first light source 102A and the S-polarized light from the second light source 102B are unified to one of the S-polarized light and the P-polarized light (the S-polarized light in the above-described case) by the π-cell 105.

A liquid crystal display panel 3F is a transmission type liquid crystal display panel provided with a color filter. A light-incidence-side polarizer of the liquid crystal display panel 3F transmits the S-polarized light. The liquid crystal display panel 3F is driven by an LDC driver 122. In addition, the first light source 102A and the second light source 102B are pulse-driven with phases thereof being shifted by 180 degrees each other by an LED lighting circuit 123. Then, the LCD driver 122, the LED lighting circuit 123, and the π-cell switch circuit 121 are controlled by a control circuit 124. An ON/OFF edge (switching edge) of the π-cell 105, as shown in FIG. 18, is in an overlapping period (preferably right in the middle of the period) of the pulsed emission of the first light source 102A and the pulsed emission of the second light source 102B. That is, the control circuit 124 controls the π-cell switch circuit 121 and the LED lighting circuit 123 so that such the control is performed. Thus, the ON/OFF edge of the π-cell 105 is in the overlapping period of the pulsed emission of the first light source 102A and the pulsed emission of the second light source 102B, it is possible to prevent a light amount from being decreased during a switching period of the π-cell 105. It is noted that, although the π-cell 105 is shown as the switching polarized light rotating element, it is not limited to use the π-cell 105. Furthermore, the case where the P-polarized light from the first light source 102A and the S-polarized light from the second light source 102B are unified to one of the S-polarized light and the P-polarized light (S-polarized light in the above-described case) is exemplified. However, the polarized light is not limited to be unified to one of the S-polarized light and the P-polarized light, and it is only necessary that the polarizing directions of the light from the first light source 102A and the light from the second light source 102B are redirected in a common direction. For example, in a case where a light-incidence transmitting direction of the liquid crystal display panel is inclined at 45 degrees, a configuration in which the polarized light is unified to one of the S-polarized light and the P-polarized light is not adopted, and in this case, a half wavelength plate is arranged between the π-cell 105 and the polarized light mixing element 101, for example, so as to unify the polarized light to a light having a polarizing direction corresponding to the light-incidence transmitting direction inclined at 45 degrees.

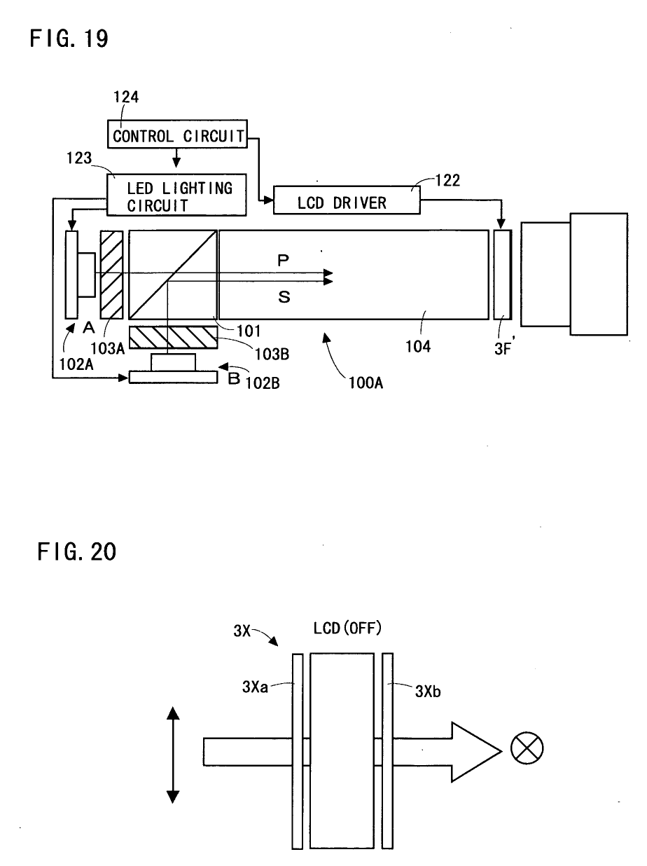

FIG. 19 is a descriptive diagram showing a projection type video display using an illuminating device 10A. The projection type video display is provided with a liquid crystal display panel 3F′.

FIG. 20 shows structure of a general normally-white-type liquid crystal display panel 3X. A light-incidence-side polarizer 3Xa and a light-exit-side polarizer 3Xb of the liquid crystal display panel 3X are arranged in such a manner that directions of light transmission axes are different by 90 degrees each other. When energization to pixels of the liquid crystal display panel 3X is turned off, incident light is given off from the light-exit-side polarizer 3Xb after having the polarizing direction rotated by 90 degrees, so that a display becomes a white display. On the contrary, when the energization to pixels is turned on, the polarizing direction of the incident light is not rotated, so that the incident light can not pass through the light-exit-side polarizer 3Xb. As a result, the display becomes a black display.

Structure of the liquid crystal display panel 3F′ is equivalent to structure in which the light-incidence-side polarizer is removed from the liquid crystal display panel 3X. In addition, the LCD driver 122 switches between a supply of a video signal for a case that the liquid crystal display panel 3F′ is regarded as the normally-white-type and a supply of a video signal for a case that the liquid crystal display panel 3F′ is regarded as a normally-black-type, according to timing of switching between the pulsed emission of the first light source 102A and the second light source 102B (switching between the P-polarized light and the S-polarized light). That is, the LCD driver 122, at the time that the polarized light of a first polarizing direction is incident on the liquid crystal display panel 3F′, supplies to the liquid crystal display panel 3F′ one of two signals, that is, a video signal generated for a liquid crystal panel in which a polarizing direction of incident light crosses a transmitting direction of a light-exit side polarizer, and a video signal generated for a liquid crystal panel in which the polarizing direction of incident light is in parallel with the transmitting direction of the light-exit side polarizer. On the other hand, the LCD driver 122, at the time that the polarized light of a second polarizing direction is incident on the liquid crystal display panel 3F′, supplies to the liquid crystal display panel 3F′ the other of the above-mentioned two video signals.

Hereinafter, a specific description will be further given. It is noted that, in the description below, the light-exit-side polarizer of the liquid crystal display panel 3F′ transmits the S-polarized light. At a timing that the first light source 102A is lighted and the P-polarized light is emitted, the LCD driver 122 supplies a normally white-use video signal to the liquid crystal display panel 3F′. When the video signal equivalent to a white color is supplied to the liquid crystal display panel 3F′ (that is, when the energization to the pixels of the liquid crystal display panel 3F′ is turned off), the P-polarized light incident on the liquid crystal display panel 3F′ becomes the S-polarized light as a result the polarizing direction being rotated by 90 degrees and can pass through the light-exit-side polarizer. As a result, the display becomes a white display. On the other hand, at a timing that the second light source 102B is lighted and the S-polarized light is emitted, the LCD driver 122 supplies a normally black-use video signal to the liquid crystal display panel 3F′. When the video signal equivalent to the white color is supplied to the liquid crystal display panel 3F′ (that is, when the energization to the pixels of the liquid crystal display panel 3F′ is turned on), the polarizing direction of the S-polarized light incident on the liquid crystal display panel 3F′ is not rotated, so that the S-polarized light can pass through the light-exit-side polarizer and the display becomes the white display.

Therefore, with the projection type video display shown in FIG. 19, the LCD driver 122 switches between the normally white-use video signal supply and the normally black-use video signal supply in accordance with a timing of alternate lighting of the light source 102, and these two video signals are alternately supplied to the liquid crystal display panel 3F′ (without the light-incidence-side polarizer). As a result, it is possible to realize the display of a video without using the π-cell 105.

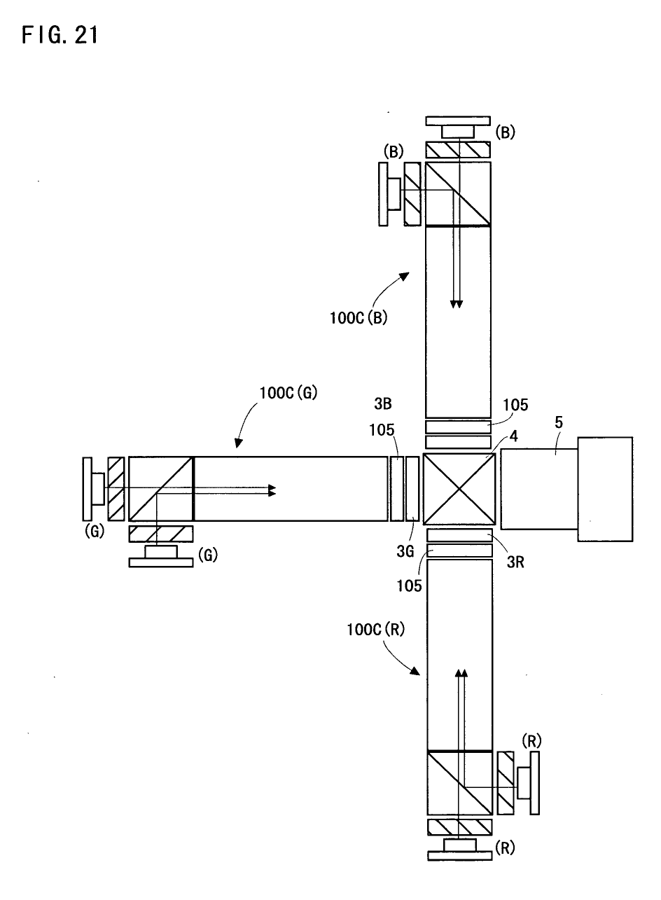

FIG. 21 is a descriptive diagram showing a three-panel projection type video display. The projection type video display is provided with three illuminating devices 100C. One of the three illuminating devices 100C emits light in red, another emits light in green, and the remaining one emits light in blue. That is, the illuminating device 100C is configured to be the same as the illuminating device 100B except that the former is provided with the light sources (LED chips) that emit light of respective colors as each light source. The light of respective colors emitted from each illuminating device 100C is respectively guided to the liquid crystal display panels 3R, 3C, and 3B via the π-cell 105. Modulated light (image light of respective colors) modulated by passing through the liquid crystal display panels 3R, 3G, 3B is combined by a cross dichroic prism 4, and changed to full-color image light. This full-color image light is projected by a projection lens 5, and displayed on a screen.

It is noted that, in the three-panel type configuration in FIG. 21, a combination of the respective colors-use liquid crystal display panels without the light-incidence-side polarizer and the illuminating device 100A (see FIG. 19) can be adopted.

Furthermore, a configuration in which the light in white emitted from the illuminating device 100A or the illuminating device 100B is separated into light of respective colors by a dichroic mirror and others, and the light of respective colors is respectively guided to the respective colors-use liquid crystal display panels may also be adopted. Modulated light (the light of respective colors) modulated by passing through the liquid crystal display panels is combined by the cross dichroic prism 4, and changed to full-color image light. This full-color image light is projected by a projection lens, and displayed on a screen.

In addition, in a case of using the illuminating device 100A in which the S-polarized light is emitted as it is and P-polarized light is emitted as it is, the first light source 102A and the second light source 102B need not necessarily be lighted alternately. For example, two kinds of combinations of LED chips for emitting the light in white in each light source may be prepared. The instant the LED chips of one combination are allowed to emit pulses of light in the first light source, the LED chips of the same combination are similarly allowed to emit pulses of light in the second light source. Moreover, the instant the LED chips of the other combination are similarly allowed to emit pulses of light in the first light source, the LED chips of the same combination are allowed to emit pulses of light in the second light source. In this case, the light amount difference between the P-polarized light and the S-polarized light still exists. However, the P-polarized light and S-polarized light emitted at the same time are combined, so that it is possible to prevent an amount of light emitted from the illuminating device 100A from changing. Such the configuration (control) can also be applied to an illuminating device that emits light of respective colors.

Furthermore, a time-division full-color projection type video display using one piece of DMD and the illuminating device 100A can be configured. For example, when the light in red-use LED chips of the first light source 102A and the second light source 102B are made to emit pulses of light, a red color-use video signal is supplied to the DMD, when the light in green-use LED chips of the first light source 102A and the second light source 102B are made to emit pulses of light, a green color-use video signal is supplied to the DMD, and when the light in blue-use LED chips of the first light source 102A and the second light source 102B are made to emit pulses of light, a blue color-use video signal is supplied to the DMD. That is, it is possible that the video display panels are driven by a time-dividing manner by synchronizing with respective timings of the pulsed emission of the respective colors-use LED chips.

Moreover, a time-division full-color projection type video display using one liquid crystal display panel and the illuminating device 100B can be configured. For example, in a state where the red color-use video signal is supplied to the one liquid crystal display panel, the light in red-use LED chips of the first light source 102A are made to emit pulses of light (at this time, the π-cell 105 is off, for example), and in addition, the light in red-use LED chips of the second light source 102B are made to emit pulses of light (at this time, the π-cell 105 is on, for example). Next, in a state where the green color-use video signal is supplied to the one liquid crystal display panel, the light in green-use LED chips of the first light source 102A are made to emit pulses of light (at this time, the π-cell 105 is off, for example), and in addition, the light in green-use LED chips of the second light source 102B are made to emit pulses of light (at this time, the π-cell 105 is on, for example). Next, in a state where the blue color-use video signal is supplied to the one liquid crystal display panel, the light in blue-use LED chips of the first light source 102A are made to emit pulses of light (at this time, the π-cell 105 is off, for example), and in addition, the light in blue-use LED chips of the second light source 102B are made to emit pulses of light (at this time, the n-cell 105 is on, for example). That is, each of the respective colors-use video signals is supplied to the liquid crystal display panel, the LED chips corresponding to the color indicated by the video signal are lighted sequentially in the two light sources, and then, the switching of the π-cell 105 is performed according to the timing of the lighting. In this case, the polarized light mixing element (the π-cell) capable of switching at a high frequency is desirable.

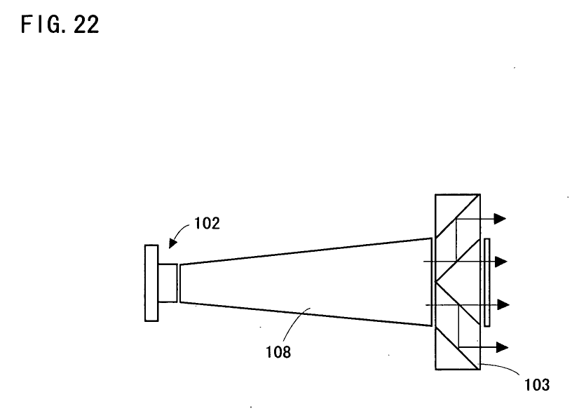

Furthermore, in the light source 102 used for the illuminating devices described above, as shown in FIG. 22, a tapered-shaped rod integrator 108 (a size of a light-exit surface is larger than a size of a light-incidence surface) may be provided. A shape and the size of the light-incidence surface of the rod integrator 108 approximately coincide with a shape and a size of a light-emission surface of the light source 102, and a shape and the size of the light-exit surface approximately coincide with a shape and a size of a light-incidence surface of the polarization conversion system 103.

Moreover, each illuminating device may be provided with an integrator lens formed of a first fly's eye lens and a second fly's eye lens instead of the rod integrator 104. The first fly's eye lens is arranged on the light-exit side of each polarization conversion system 103. In addition, the second fly's eye lens is arranged on the light-exit side of the polarization mixing element 101. It is noted that the second fly's eye lens are shared by a plurality of light sources. Each pair of lenses of the first fly's eye lens and the second fly's eye lens guides light emitted from each light source to an entire surface of the video display element.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. An illuminating device, comprising:
a plurality of light sources formed of one or a plurality of solid light-emitting elements and arranged so as to face different directions one another;
a lighting control means for allowing the solid light-emitting element to emit pulses of light; and
an optical path changing means for generating a state where light emitted by a pulsed emission in one light source is guided to a specific optical path and a state where light emitted by a pulsed emission in another light source is guided to the specific optical path.

2. An illuminating device according to claim 1, wherein the optical path changing means is formed of a transmission and reflection switching means for switching between the transmission and the reflection.

3. An illuminating device according to claim 2, wherein the transmission and reflection switching means is formed of a switching diffraction element for switching between the transmission and the reflection by an energization control synchronous with the pulsed emission.

4. An illuminating device according to claim 3, wherein three light sources are provided, and the switching diffraction elements are arranged crosswise on a crossing position of the light emitted from the three light sources.

5. An illuminating device according to claim 2, wherein the transmission and reflection switching means has transmitting regions and reflecting regions alternately in a plane surface and switches positions of the transmitting regions and the reflecting regions by a reciprocating movement synchronous with the pulsed emission.

6. An illuminating device according to claim 2, wherein the transmission and reflection switching means has the transmitting regions and the reflecting regions alternately in a circular disk and switches positions of the transmitting regions and the reflecting regions by a rotation synchronous with the pulsed emission.

7. An illuminating device according to claim 1, wherein the optical path changing means is formed of a transmission optical path changing means for changing an optical path direction when light is transmitted.

8. An illuminating device according to claim 7, wherein the transmission optical path changing means is formed of a switching diffraction element for changing an advancing direction of light by diffraction according to an energization control synchronous with the pulsed emission.

9. An illuminating device according to claim 8, wherein three light sources are provided, and the switching diffraction elements are arranged crosswise on a crossing position of light emitted from the three light sources.

10. An illuminating device according to claim 1, wherein the optical path changing means is formed of a reflection optical path changing means for changing an advancing direction of light by reflection.

11. An illuminating device according to claim 10, wherein the reflection optical path changing means is formed of a mirror device for changing a direction of a mirror by an energization control synchronous with the pulsed emission.

12. An illuminating device according to claim 1, comprising;
a first fly's eye lens provided on a light-emission side of each light source, and
a second fly's eye lens provided on the specific optical path, paired with the first fly's eye lens, and integrating and guiding light to an object to be illuminated.

13. An illuminating device according to claim 12, comprising a polarization conversion system on a light-exit side of the second fly's eye lens.

14. An illuminating device according to claim 1, comprising a tube-shaped or stick-shaped optical integrator on the specific optical path.

15. An illuminating device according to claim 1, wherein each light source emits light in the same one color.

16. An illuminating device according to claim 1, wherein each light source emits light in white.

17. A projection type video display, comprising a plurality of illuminating devices each of which emits light in different color, wherein at least one of the illuminating devices is the illuminating device according to claim 15, light of respective colors emitted from the respective illuminating devices is optically modulated by each display panel, and the modulated light of respective colors is combined and projected.

18. A projection type video display, comprising a plurality of illuminating devices each of which emits light in different color, wherein at least one of the illuminating devices is the illuminating device according to claim 15, light of respective colors emitted from the respective illuminating devices is guided in the same direction and optically modulated by a single display panel, and the modulated light is projected.

19. A projection type video display, comprising the illuminating device according to claim 16, wherein light in white emitted from the illuminating device is optically modulated by a single display panel and the modulated light is projected.

20. A projection type video display, comprising the illuminating device according to claim 16, wherein light in white emitted from the illuminating device is separated into light in red, light in green, light in blue, light of respective colors is optically modulated by each display panel, and the modulated light of respective colors is combined and projected.

21. An illuminating device according to claim 1, comprising:
a first polarization conversion system for converting light emitted from a first light source out of the plurality of light sources into polarized light of a first polarizing direction; and
a second polarization conversion system for converting light emitted from a second light source different from the first light source into polarized light of a second polarizing direction perpendicular to the first polarizing direction, wherein the optical path changing means guides the light emitted from the first light source and converted into the polarized light of the first polarizing direction to a specific optical path by one of two functions, transmission and reflection, and guides the light emitted from the second light source and converted into the polarized light of the second polarizing direction to the specific optical path by the other of the two functions, the transmission and the reflection.

22. An illuminating device according to claim 21, wherein amounts of the light emitted from the first light source and the light emitted from the second light source are rendered different each other such that amounts of the polarized light of the first polarizing direction and the polarized light of the second polarizing direction obtained by passing through the optical path changing means are equalized.

23. An illuminating device according to claim 21, comprising:
a first fly's eye lens provided on a light-emission side of each light source; and
a second fly's eye lens provided on the specific optical path, paired with the first fly's eye lens, and integrating and guiding light to an object to be illuminated.

24. An illuminating device according to claim 21, comprising a tube-shaped or stick-shaped optical integrator on the specific optical path.

25. An illuminating device according to claim 21, comprising:
a switching polarized light rotating element for switching between a function state where a polarizing direction of received light is rotated by 90 degrees and a function state where the polarizing direction is not rotated, by on and off of an energization; and
a switching circuit for controlling the switching polarized light rotating element, wherein the switching polarized light rotating element is arranged on the specific optical path, the lighting control means performs a lighting control so as to stagger timing of the pulsed emissions of the first light source and the second light source, the switching circuit turns on and off the switching polarized light rotating element in synchronization with timing of the pulsed emission of the solid light-emitting element, and polarizing directions of light obtained by passing through the switching polarized light rotating element are redirected into a common direction.

26. An illuminating device according to claim 21, wherein each light source emits light in the same one color.

27. An illuminating device according to claim 21, each light source emits light in white or light of respective colors to be the light in white.

28. A projection type video display, comprising:
a plurality of illuminating devices each of which emits light in different color, wherein at least one of the illuminating devices is the illuminating device according to claim 26, light of respective colors emitted from the respective illuminating devices is optically modulated by each display panel, and the modulated light of respective colors is combined and projected.

29. A projection type video display, comprising a plurality of illuminating devices each of which emits light in different color, wherein at least one of the illuminating devices is the illuminating device according to claim 26, light of respective colors emitted from the respective illuminating devices is guided in one direction and optically modulated by a single display panel, and the modulated light is projected.

30. A projection type video display, comprising the illuminating device according to claim 27, wherein light in white or light of respective colors to be the light in white, emitted from the illuminating device, is optically modulated by a single display panel, and the modulated light is projected.

31. A projection type video display, comprising the illuminating device according to claim 27, wherein light in white emitted from the illuminating device is separated into light of respectively different colors, light of respective colors is optically modulated by each display panel, and the modulated light of respective colors is combined and projected.

32. A projection type video display according to any one of claims 28 to 31, comprising:
a liquid crystal display panel without a light-incidence side polarizer as the display panel; and
a panel driving circuit for driving the liquid crystal display panel, wherein the lighting control means performs a lighting control so as to stagger timing of the pulsed emissions of the first light source and the second light source, and the panel driving circuit, at the time that the polarized light of the first polarizing direction is incident on the liquid crystal display panel, supplies to the liquid crystal display panel one of two video signals, that is, a video signal generated for a liquid crystal panel in which a polarizing direction of incident light crosses a transmitting direction of a light-exit side polarizer, and a video signal generated for a liquid crystal panel in which the polarizing direction of incident light is in parallel with the transmitting direction of the light-exit side polarizer, on the other hand, at the time that the polarized light of the second polarizing direction is incident on the liquid crystal display panel, supplies to the liquid crystal display panel the other of the above-mentioned two video signals.

33. An illuminating device according to claim 25, wherein each light source emits light in the same one color.

34. An illuminating device according to claim 25, wherein each light source emits light in white or light of respective colors to be the light in white.

35. A projection type video display, comprising a plurality of illuminating devices each of which emits light in different color, wherein at least one of the illuminating devices is the illuminating device according to claim 33, light of respective colors emitted from the respective illuminating devices is optically modulated by each display panel, and the modulated light of respective colors is combined and projected.

36. A projection type video display, comprising a plurality of illuminating devices each of which emits light in different color, wherein at least one of the illuminating devices is the illuminating device according to claim 33, light of respective colors emitted from the respective illuminating devices is guided in one direction and optically modulated by a single display panel, and the modulated light is projected.

37. A projection type video display, comprising the illuminating device according to claim 34, wherein light in white or light of respective colors to be the light in white, emitted from the illuminating device, is optically modulated by a single display panel, and the modulated light is projected.

38. A projection type video display, comprising the illuminating device according to claim 34, wherein light in white emitted from the illuminating device is separated into light of respectively different colors, the light of respective colors is optically modulated by each display panel, and the modulated light of respective colors is combined and projected.

39. A projection type video display according to any one of claims 35 to 38, comprising a liquid crystal display panel as the display panel.

40. A projection type video display according to any one of claims 28 to 31, or any one of claims 35 to 38, wherein a level of a video signal supplied to the display panel in receiving polarized light of a first polarizing direction and a level of a video signal supplied to the display panel in receiving polarized light of a second polarizing direction are rendered different each other.

41. A projection type video display according to claim 32, wherein a level of a video signal supplied to the display panel in receiving the polarized light of the first polarizing direction and a level of a video signal supplied to the display panel in receiving the polarized light of the second polarizing direction are rendered different each other.

42. A projection type video display according to claim 39, wherein a level of a video signal supplied to the display panel in receiving polarized light of a first polarizing direction and a level of a video signal supplied to the display panel in receiving polarized light of a second polarizing direction are rendered different each other.

43. An illuminating device according to claim 21, the optical path changing means is a polarizing beam splitter made of glass in a cubic shape.
